(19) United States
(12) Patent Application Publication
(10) Pub. No.: US 2010/0325685 A1
(43) Pub. Date: Dec. 23, 2010

(54) Security Integration System and Device

(76) Inventor: Jamie Sanbower, Harpers Ferry, WV (US)

Correspondence Address: MCKENNA LONG & ALDRIDGE LLP, 1900 K STREET, NW, WASHINGTON, DC, 20006, US

(21) Appl. No.: 12/486,309

(22) Filed: Jun. 17, 2009

(51) Int. Cl. G06F 17/00; G06F 9/00; G06F 15/16

(52) U.S. Cl. 726/1; 726/11; 709/206; 726/23; 726/3

(57) ABSTRACT

The present disclosure generally relates to systems and devices that share information related to computer and network security. In an embodiment, an integration device can receive a notification of a security event at a security device. The integration device can compare the contents of the notification against a set of rules, select actions to take based on the set of rules at other security devices, establish a connection to the other security devices, and take the actions over the connection. The integration device can take the actions by sending commands understood by the other security devices over the connection. The other security devices can be of different platforms than the security device or not interoperable with the security device. Additionally, the integration device can receive information related to log entries, security incidents, transaction data, or configuration data, and take actions based on this information at other security devices.

### BACKGROUND

### Field of Invention

The present disclosure generally relates to security. More specifically, the present disclosure relates to systems and devices which share information related to computer and network security.

### Discussion of the Related Technology

Generally described, a computer network is a group of interconnected computers. Computer network security typically includes provisions or policies used to protect the network and network resources from unauthorized access or use, and continuous monitoring of the network. Security management and monitoring of a computer or computer network typically involves the use of software and hardware, such as antivirus software, intrusion prevention systems, a firewall, network access control systems, etc. to maintain security of the network and computing devices on the network. Unfortunately, these software and hardware systems for security management typically do not share information.

In some environments, a conventional security information management system can be used to collect data from these systems, such as log files or security event logs. After collecting the data, the security information management system may perform trend analysis or filter the data. Alerts may then be sent to a system administrator by displaying consolidated information on a console, for example. Any actions taken based on the issued alerts typically require intervention by the system administrator. Accordingly, software and hardware systems for security management and security information management systems are often ineffective because of these and other shortcomings.

### SUMMARY

The present disclosure generally relates to security for computing devices and networks. In an illustrative embodiment, a system may include an integration device which receives information, such as log entries, security incidents, transaction data, configuration data, posture assessment data, reputation databases, etc. This information may be sent to the integration device by a security information management system or a security device where the information originated, for example. The integration device may compare the information against rules to determine actions to take at other security devices, and may take actions on the other security devices based on the rules.

In exemplary embodiments, the other security devices may be of different platforms or not be interoperable with one another. For example, the other security devices can include a firewall, intrusion detection or prevention system, network access control system, etc. The integration device can take the actions by setting up a connection with the other security devices and send commands over the connection using an interface understood by the other security devices. The integration device may further report the actions taken at the other security devices to the security information management system, which can allow the system to be feedback driven.

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory and should not be construed as limiting the scope of the claims.

### BRIEF DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. In the drawings:

FIGS. 1A-C illustrate block diagrams of exemplary systems capable of sharing security information, according to embodiments of the disclosure;

FIG. 2 illustrates routines performed by exemplary components of an integration device, according to an embodiment of the disclosure;

FIGS. 3-4 illustrate routines and actions performed by exemplary components of an integration device, according to embodiments of the disclosure; and

FIG. 5 illustrates a flow diagram of security management performed by exemplary components of the systems of FIGS. 1A-C, according to an embodiment of the disclosure.

### DESCRIPTION OF THE EMBODIMENTS

The present disclosure relates to computer and network security management. In some embodiments, a security system and integration device is disclosed that can share information between different security devices to allow the different security devices to make more informed decisions or take actions to improve security of computing devices or a computer network. The security devices may monitor and detect security events on computing devices or a computer network and be capable of taking actions on the computing devices or the computer network. The integration device can be employed to share information from the security devices or a security information management system, such as transaction data related to data flowing through the network or computing devices; configuration data related to hardware or software systems utilized by the network or computing devices; logs or log entries, security incident data related to the occurrence of multiple security events; etc.

In an embodiment, the integration device may receive information from a security information management system or security devices that may monitor, analyze, protect, and reduce security threats to the monitored network or computing devices using certain actions. The integration device may process the information to determine additional actions to take on other security devices, which can be different than the security devices where the information originated, to further reduce the risk of security threats to the network. The actions may improve overall security of the monitored computer network and computing devices that reside on the network.

In contrast to existing systems, in which actions are taken by a system administrator, the integration device can automatically take actions on various security devices, which may include hardware and software, in order to monitor, analyze, protect, and reduce security risks to the monitored network and associated computing devices. For example, the integration device may establish connections with the security devices and take the actions over the connections by sending commands understood by the security devices. The actions taken can improve security management of the computer network and computing devices being monitored by the security system by feeding information back to the components of the security system. For example, information related to the actions taken across the different security devices may be fed back to the security information management system, security devices, or retained by the integration device in order to determine subsequent actions to take at other security devices, such as the security device where the information originated. The high level of integration provided by integration device can be used to create a self-defending network.

Reference will now be made in detail to the specific embodiments of the present disclosure, examples of which are illustrated in the accompanying drawings. Wherever possible, the same reference numbers will be used throughout the drawings to refer to the same or like parts.

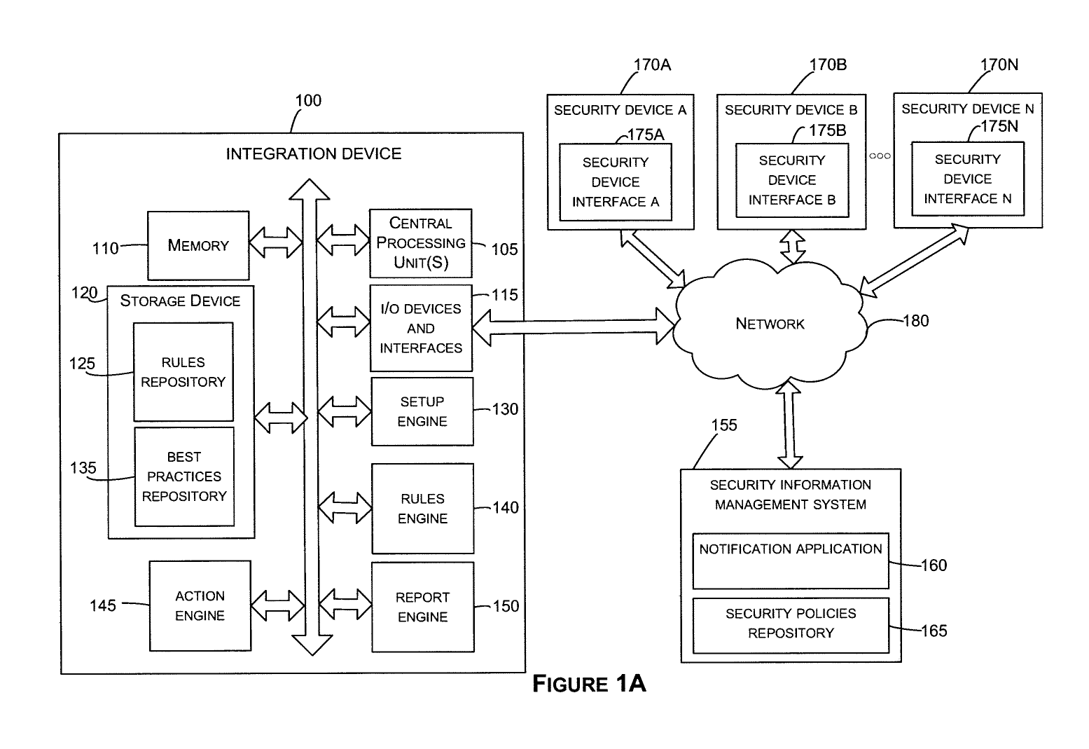

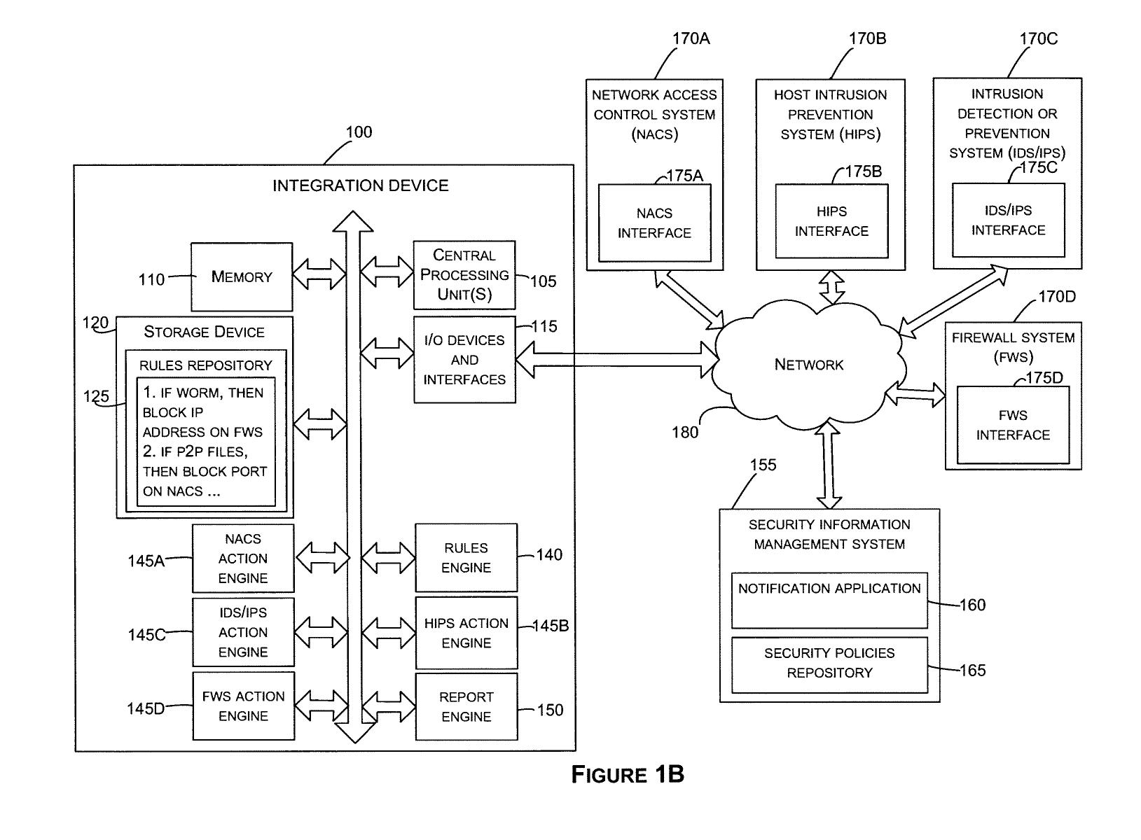

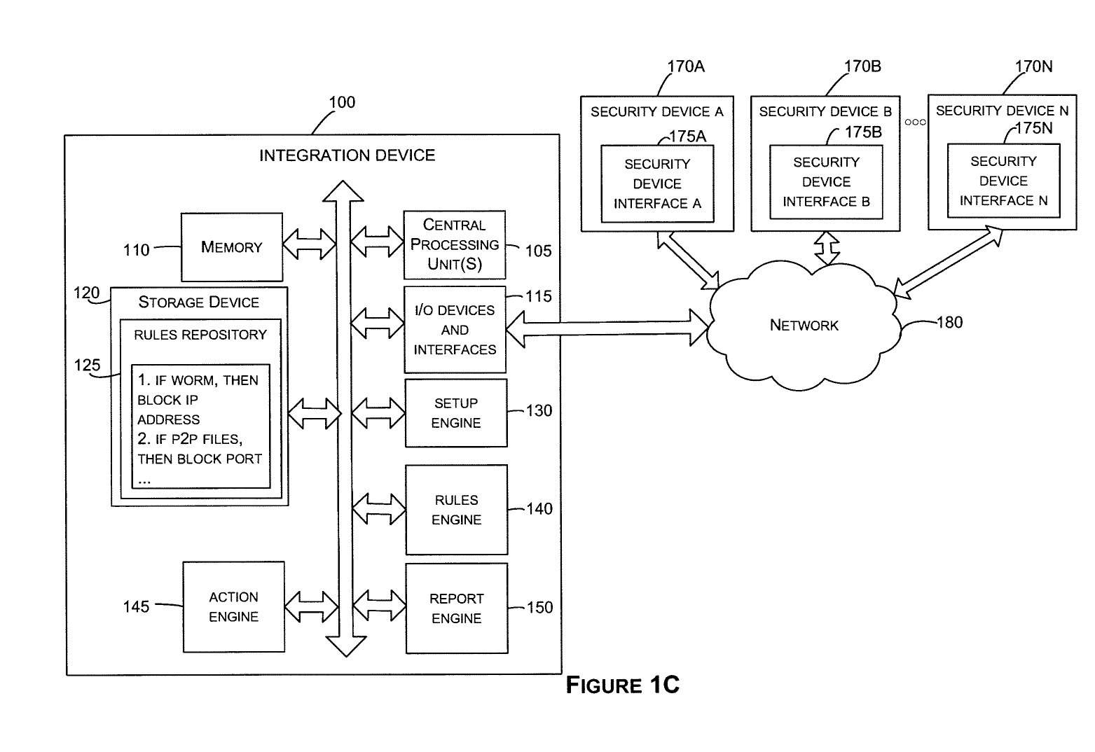

FIGS. 1A-C illustrate block diagrams of exemplary systems capable of sharing security information. As shown, an integration device 100 communicates with a security information management system (SIMS) 155 and security devices 170A, 170B, and 170N (representative of any number of security devices) over a network 180. Communication within the system may take place over network 180 using sockets, ports, and other mechanisms known in the art. The communication may also be via wires, wireless technologies, cables, or other digital or analog techniques and devices to perform those techniques over a local area network (LAN), wide area network (WAN), or the internet, for example. Of note, integration device 100, security information management system 155, and security devices 170A-N may reside on physically separate machines or be on the same machine.

Security devices 170-A-N may be a computing system, such as one or more computer servers or a peer-to-peer architecture, network device, database, software, or other device that can monitor and detect security events on a monitored computer network or computing devices, and take actions on the computer network or computing devices when an event occurs. For example, security devices 170A-N can include a host intrusion prevention system (HIPS), network access control system (NACS), intrusion detection system (IDS), intrusion prevention system (IPS), firewall system, anti-virus software, routers, reputation databases (e.g., of known network attackers), blacklist database, greylist database, web filters, electronic mail filters, vulnerability assessment tools, host security software, anti-X software, anti-X network security appliances, host patching solutions, device inventory solutions, switches, load balancers, web application firewalls, web application security devices, or other intrusion detection systems or devices as would be appreciated by one of skill in the art.

In an embodiment, security devices 170A-N may include one or more logs in any format, such as entries of events or activities which may occur on the monitored computer network or associated computing devices. In addition, security devices 170A-N may include information related to entries in a syslog server, secure syslog, application logs, event logs, access logs, alerts, alarms, network packets, network usage, network attacks, electronic mail messages, security incidents (e.g., multiple events), etc. This information may be generated on security devices 170A-N or by computing devices and applications on the computer network which is being monitored. For example, when security devices 170A-N includes a firewall system, a variety of internet protocol addresses and accessed ports may be stored in an event log on the firewall system. In addition, security devices may include information related to software and hardware configurations of computing devices and network devices on the monitored network (e.g., type of operating systems, services offered, etc.) and transaction data related to data flowing through the computer network or computing devices.

In exemplary embodiments, some of the security devices 170A-N may be of different platforms or made by manufacturers, and thus not be interoperable or integrated with one another. Additionally, security devices 170A-N may be integrated partially, for example, a subset of security features or functionality may be integrated. Security devices 170A-N can include software or hardware that may control access or use of a computer network or computing devices on the network and information stored therein. For example, security devices 170A-N may include a firewall system that blocks incoming connections from external computing devices associated with certain internet protocol addresses, which may be blacklisted or greylisted, or limit port access to internal computing devices on the network.

The security devices 170A-N can include one or more central processing units (CPUs), a memory, such as random access memory (RAM), to store information temporarily or permanently, one or more input/output (I/O) devices and interfaces, such as a network interface or card, keyboard, and the like to receive or transmit data. Security devices 170A-N may further comprise a storage device, such as one or more hard drives. The storage device includes one or more data repositories having a variety of structured or unstructured content, such as file systems or databases of information from the computing devices or computer networks being monitored and managed. Components of security devices 170A-N can be interconnected using a standards based bus system, such as Peripheral Component Interconnect (PCI), for example. Security devices 170A-N may include various operating systems, hardware resources, and be on different network domains. The operating systems may manage the various hardware resources and provide a graphical user interface (GUI) or command line interface (CLI).

Security devices 170A-N may further include respective security device interfaces 175A-N that may allow an integration device 100 to take actions on security devices 170A-N. Security device interfaces 175A-N can include an application programming interface or command line interface. In addition, security devices interfaces 175A-N can be an executable program that allows commands or inputs to be provided in a language that is understood by security devices 170A-N, such as in a scripting language, programming language, or other computer executable program code, and executes them. Security device interfaces 175A-N may also include protocols and applications that employ protocols, such as secure socket layer (ssl), hyper text transport protocol (HTTP), remote copy protocol (rcp), secure copy protocol (scp), file transfer protocol (ftp), secure file transfer protocol (sftp), secure shell (ssh), telnet, electronic mail, network file system (NFS), etc.

Security information management system 155 may be a computing system, such as one or more computer servers or a peer-to-peer architecture, network device, mobile device, or other device that can collect information or data from security devices 170A-N, such as that described with respect to security devices 170A-N. The collected information may be analyzed by security information management system 155 to improve the security of the computing devices or computer networks being monitored or analyzed. For example, the collected information may be analyzed to detect security events and incidents, such as a denial-of-service attack, and determine possible countermeasures to take.

Security information management system 155 may transmit or send information to integration device 100, such as the collected information described with respect to security devices 170A-N above, or data related to security events, incidents, etc., which may be based on analysis of the collected information. As shown, security information management system 155 may include a notification application 160 and security policies repository 165. Security policies repository 165 may include rules that recommend actions for the system administrator to take when the collected information or analysis of the collected information satisfies some condition(s). For example, the actions may include sending a message, such as a terminal message to a system administrator, shutting down a monitored network or computing device, disabling a port, etc.

Notification application 160 can allow an integration device 100, to take actions on security devices 170A-N based on the collected information or analysis of the collected information. Notification application 160 may be configured to send the collected information or analyzed information as a message, alarm, alert, etc. In an embodiment, notification application 160 may be executed as an action of one of the rules of security policies repository 165. Notification application 160 may send the information over network 180 to integration device 100 using particular formats or protocols, for example: electronic mail, simple network management protocol (SNMP), extensible markup language (XML), hypertext transport protocol (HTTP), secure socket layer (SSL), syslog server, secure syslog, remote copy protocol (rcp), secure copy protocol (scp), file transfer protocol (ftp), secure file transfer protocol (sftp), network file system (NFS), etc. Alternatively, notification application 160 may allow a system administrator to log in from security information management system 155 into integration device 100, and send or input the information.

Security information management system 155 can also include one or more central processing units (CPUs), a memory, such as random access memory (RAM), to store information temporarily or permanently, one or more input/output (I/O) devices and interfaces, such as a network interface or card, keyboard, and the like to receive or transmit data. Security information management system 155 may further comprise a storage device, such as one or more hard drives.

The storage device includes one or more data repositories having a variety of structured or unstructured content, such as file systems or databases of the collected information from security devices 170A-N and/or information based on the analysis of the collected data, such as network incidents, events, attacks, countermeasures, etc. In addition, storage device may store notification application 160 and security policies repository 165. Components of security information management system 155 can be interconnected using a standards based bus system, such as Peripheral Component Interconnect (PCI), for example. Security information management system 155 may include various operating systems, hardware resources, and be on different network domains. The operating systems may manage the various hardware resources and provide a graphical user interface (GUI).

The integration device 100 can be a computing system, such as one or more distributed computer servers or a peer-to-peer architecture, network device, virtual machine, etc., which can share security information among the plurality of security devices 170A-N and take actions on the security devices 170A-N. Integration device 100 can include one or more central processing units (CPUs) 105. In addition, integration device 100 can also include a memory 110, such as random access memory (RAM), to store information temporarily or permanently. Integration device 100 may further include one or more input/output (I/O) devices and interfaces 115, such as a network interface or card, keyboard, and the like to receive or transmit data.

Integration device 100 may further comprise a storage device 120, such as one or more hard drives. The components of integration device 100 can be interconnected using a standards based bus system, such as Peripheral Component Interconnect (PCI), for example. The integration device 100 may include various operating systems, hardware resources, and be on different network domains. The operating systems may manage the various hardware resources and provide a graphical user interface (GUI) or command line interface (CLI).

Storage device 120 includes one or more data repositories having a variety of structured or unstructured content, such as file systems or databases. As shown, storage device 120 includes a rules repository 125 and best practices repository 135. The rules repository 125 can include one or more rules that may specify conditions and actions to take when conditions may be satisfied. A condition may be any type of information collected from security devices 170A-N or security information management system 155, or values for the information. For example, a condition can include software or hardware configurations, events, incidents, transaction data, network attacks, network usage data, internet protocol addresses, reputation databases (e.g., of known network attackers), etc. An action may include an act to take at security devices 170A-N or security information management system 155 when a condition may be met. The rules may be based on correlations that indicate when certain types of information may be received that satisfy a condition of a rule, then taking a particular action can enhance security of a monitored computer network or computing devices. For example, when the information collected from security information management system 155 or security devices 170A-N may tend to indicate an attack is occurring on the monitored network, then taking actions on security devices 170A-N can reduce damage from the attack. In some embodiments, the actions taken may include blocking a port or internet protocol address of an attacker's machine using security devices 170A-N, such as a firewall system.

The rules repository 125 can be populated using information from security information management system 155, such as security policies repository 165. In addition, rules repository 125 may be populated using setup engine 130 that allows customized rules and actions to be put in place by a system administrator, for example. In an embodiment, a best practices repository 135 may also be used to provide a set of pre-configured or default rules and actions to populate rules repository 125 or in place of rules repository 125. This can advantageously allow integration device 100 to be “plug and play” with any security system and use a set of pre-defined best practices for an automated security response to information provided by security information management system 155 and security devise 170A-N.

Integration device 100 and other devices shown, such as security information management system 155 and security devices 170A-N, may include one or more engines or applications. In general, the word engine (used interchangeably with the word module, interface, or application), as used herein, refers to logic embodied in hardware or software instructions, which can be written in a programming language, such as Java™, C, C++, etc., for example. A software engine can be compiled into executable programs or written in interpreted programming languages, such as Perl or Visual Basic script. Software engines may be callable from other engines or themselves. Generally, the engines described herein refer to logical modules that may be merged with other engines or divided into sub-engines despite their physical organization. The engines can be stored in any type of computer readable medium or computer storage device and be executed by one or more general purpose computers. In addition, the methods and processes disclosed herein can alternatively be embodied in one or more engines or specialized computer hardware.

As shown, integration device 100 includes a rules engine 140. Generally, rules engine 140 can be executed when integration device 100 receives information (e.g., security event data, configuration data, log data, transaction data, incident data, etc.) using the protocols and formats described above. Rules engine 140 may receive this information as a notification, message, alert, or alarm sent from security information management system 155 or security devices 170A-N.

In response to receiving the information, rules engine 140 may match or correlate the information against rules repository 125 to determine whether actions can be taken at security devices 170A-N (which may be different than the security device where the information originated). For example, a rule may specify that if a user accesses a port used by a file sharing application, then an action automatically may be taken at a firewall system that blocks ports associated with the file sharing application. In some embodiments, because the action may not otherwise be taken on security devices 170A-N (or may be taken after some delay has passed from a system administrator manually taking the action), this can advantageously allow the monitored computer network to have improved security. Of note, integration device 100 can allow security devices 170A-N that may be of different platforms, types, made by different manufacturers, or not interoperable with each other for one or more features (e.g., partially interoperable), to be integrated with each another. The level of integration provided by integration device 100 can be full, partial, or for a greater set of features than allowed with or without security information management system 155.

Integration device 100 may further include an action engine 145. Action engine 145 can be configured to take the actions selected by rules engine 140 on the selected security devices 170A-N. For example, after information is matched to a rule by rule engine 140, action engine 145 may establish a connection or channel to each of the security devices which correspond to where the actions can be taken. Action engine 145 may then take the actions over the connection by sending commands using security device interfaces 175A-N. For example, action engine 145 may send commands for a command line, shell, etc., over a secure socket layer or secure shell connection.

In addition, action engine 145 may be utilized by security information management system 155. For example, security information management system 155 may collect information from security devices 170A-N and correlate it with a set of rules in security policies repository 165. If a rule is met, security information management system 155 may determine actions can be taken and send the actions to take to integration device 100. The integration device 100 may then block the actions or decide to execute action engine 145 to actually take the recommended actions on security devices 170A-N by establishing a connection with the security devices 170A-N and sending commands.

Integration device 100 may also include a report engine 150. Report engine 150 may be configured to report the actions taken by the action engine 145 at security devices 170A-N to the security information management system 155 or security devices 170A-N. This can advantageously allow additional actions to be taken, based on actions which have occurred. For example, security information management system 155 may send additional security information back to integration device 100 when it receives data from report engine 150 related to actions taken at a first security device. In response to receiving the additional security information, integration device 100 may take additional actions, which can allow the security system to be feedback driven. Alternatively, report engine 150 may report this additional security information to other security devices to allow them to take actions directly. The other security devices may then report the additional security information or actions they have taken to security information management system 155.

FIG. 1B illustrates a block diagram of an exemplary system capable of exchanging security information and an exemplary rules repository. As shown, integration device 100 may include a storage device 120 having a rules repository 125 that stores a set of rules. The rules may include actions to take when a rule may be applicable to information provided by security devices 170A-D or security information management system 155.

In the illustrated embodiment, by way of example, the rules repository 125 includes a first rule and a second rule, and associated first and second actions. The first rule may specify that when a worm is detected on a computing device then a first action be taken. The first action can include blocking the internet protocol address of the associated computing device using a firewall system. The second rule may specify that if files are being sent or received by a computing device using a peer-to-peer file sharing program, then a second action be taken. The second action can include removing the system utilizing the peer-to-peer file sharing application from the network using a network access control system. Of note, rules repository 125 may include any number of additional rules and actions.

With continued reference to FIG. 1B, integration device can further include a plurality of action engines 145A, 145B, 145C, and 145D (representative of any number of action engines). In an exemplary embodiment, each of action engines 145A-D may be configured to take actions on a respective security device 170A, 170B, 170C, and 170D (representative of any number of security devices) using interfaces 175A-D (representative of any number of security device interfaces).

For example, network access control system (NACS) action engine 145A may establish a connection with NACS 170A and then use NACS interface 170A to send commands which can control operation of NACS 170A. The commands may configure NACS 170A to block a computing device from joining a monitored computer network when a virus has been detected on the computing device, or the internet protocol address of a computing device which is blacklisted or greylisted. Alternatively, NACS 170A may quarantine the computing device by placing it in a virtual local area network, for example. Host intrusion prevention system (HIPS) action engine 145B may be configured to communicate with HIPS interface 175B of HIPS 170B. For example, HIPS action engine 145B may update a database on HIPS 170B using HIPS interface 175B to add additional viruses or threats to look for on monitored computing devices. Additionally, an intrusion detection system (IDS) and/or intrusion prevention system (IPS) action engine 145C may be used to update databases and control IDS/IPS 170C using IDS/IPS interface 175C. For example, this may include updating a database of worms or attack signatures to detect on the monitored computer network. Integration device 100 can also include a firewall system (FWS) action engine 145D which can take actions on a FWS 170D using FWS interface 175D. This may include sending commands related to ports to block, applications to block, internet protocol addresses to block, etc.

In some embodiments, integration device 100 may include a rules engine 140 having one or more listeners (not shown) to listen to requests from security information management system 155 or security devices 170A-N or pollers (not shown) to poll these devices for new information. Listeners and pollers can allow integration device 100 to integrate additional types of security devices and security information management systems and allow integration device 100 be distributed across multiple platforms. For example, a rules engine and corresponding action engine set may be provided for each type of security device 170A-D and/or security information management system 155. Additionally, translators with translation rules to translate communications between different security devices and security information management systems can be used. This can enable integration device 100 to integrate different devices and translate information received from these devices in order to take actions on different security devices. Integration device 100 may thus be compatible with any type of security device and security information management system and exist as a virtual machine.

FIG. 1C illustrates a block diagram of another exemplary system for sharing security information that is optimized. As shown, security devices 170A-N communicate directly with integration device 100 over network 180 to provide security information and allow actions to be taken by integration device 100. The security information management system 155 described with reference to FIGS. 1A-B may not necessarily be used, as this functionality can be combined with integration device 100 in the same machine or device.

In exemplary embodiments, after security devices 170A-N send information to integration device 100, the integration device 100 may analyze and process the information using rules engine 140. Rules engine 140 may correlate the provided information with rules repository 125 to detect events, incidents, attacks, etc. on the monitored computer network and computing devices and select actions (e.g., countermeasures) to take. Action engine 145 may take the selected actions on security devices 170A-N, as previously described.

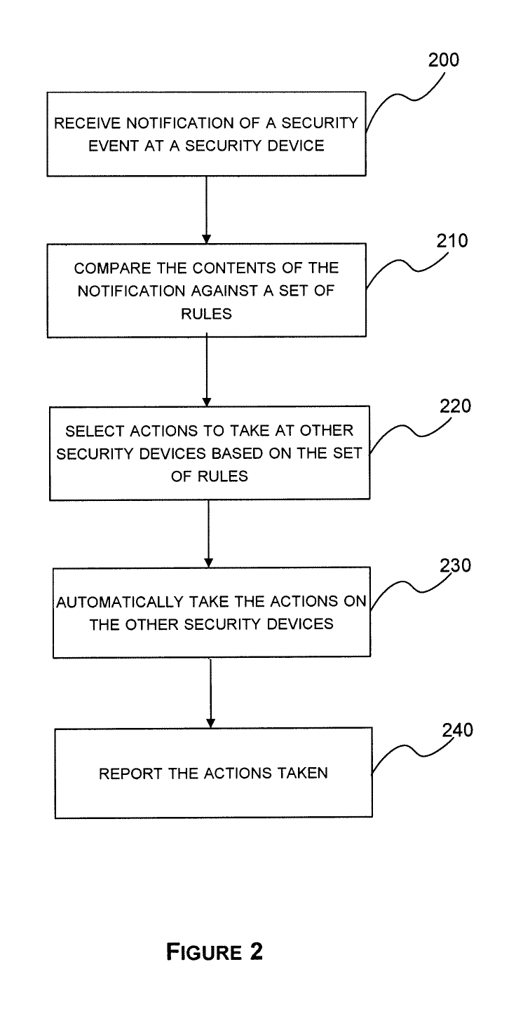

FIG. 2 illustrates routines performed by exemplary components of an integration device. In some embodiments, these routines can be performed by rules engine 140, action engine 145, and report engine 150 of integration device 100 and may use rules repository 125. Depending on the embodiment, the method of FIG. 2 can include fewer or additional blocks, and blocks can be performed in an order which may be different than illustrated.

Beginning in block 200, a notification of a security event at a security device may be received. Alternatively, the notification may be information related to an incident, transaction, attack, configuration, log data, or other information sent from a security device, such as data described with respect to FIGS. 1A-C above. The notification may be sent as a message, alert, alarm, etc. Notification may be received by integration device 100 from a security information management system 155 or directly from the security device where the security event occurred or information originated. The notification may be received in any format or protocol, including: electronic mail, simple network management protocol (SNMP), extensible markup language (XML), hypertext transport protocol (HTTP) (e.g., using HTTP post), secure socket layer (SSL), syslog server, secure syslog, remote copy (rcp), secure copy (scp), file transfer protocol (ftp), secure file transfer protocol (sftp), various application programming interfaces (APIs), etc.

Moving to block 210, the contents of the notification may be compared against a set of rules (representative of any number of rules). This comparison may be performed by rules engine 140 of integration device 100. A rule may have any number of conditions, which when satisfied, may result in any number of actions being taken. A condition may specify any type of information or values for information collected from security devices 170A-N or security information management system 155, such as software or hardware configurations, events, incidents, transaction data, network attacks, network usage data, internet protocol addresses, reputation databases (e.g., of known network attackers), etc. An action may include an action to take at security devices 170A-N or security information management system 155 when a condition may be met.

At block 220, actions may be selected to take at other security devices (which may be different than the security device where the security event occurred), based on the set of rules. In exemplary embodiments, rules engine 140 may parse contents of the notification, compare the parsed contents to a condition of a rule, and select actions to take when a condition is met. The actions taken may include sending control commands to the other security devices, updating a database, or sending any other type of information to security devices when a condition may be satisfied. For example, the selected actions may include blocking a port, blocking an internet protocol address, quarantining a computing device, etc., using the other security devices, such as a firewall system, network access control system, etc. This can advantageously improve security of the monitored computer network and computing devices by allowing security devices to utilize information from a different security device in order to take actions that reduce security risks.

Continuing to block 230, actions may automatically be taken at the other security devices. The actions may be taken by sending commands or communications to the other security devices in a language understood by the other security devices, using security device interfaces 175A-N, for example. The commands may be in a language understood by a command line interpreter, shell program, application programming interface, etc. of the other security devices. In exemplary embodiments, the actions may be sent over a connection using a variety of protocols, such as security socket layer, secure shell, HTTP, or any of the methodologies discussed above. The action engine 145 of integration device 100 may establish a connection with the other security devices and utilize security device interfaces 175A-N to send the commands.

Moving to block 240, the actions taken at the other security devices may be reported. Of note, this step may be performed by the report engine 150 of integration device 100. For example, the actions may be reported to security information management system 155 or the other security devices. In exemplary embodiments, this may enable additional actions to be taken, based on actions that have occurred by allowing the information to propagate through the security system. For example, when actions are reported to security information management system 155, new information based on the reported information may be sent to integration device 100. Based on this new information, integration device 100 may take additional actions on additional security devices, because additional rules of rules repository 125 may match the new information.

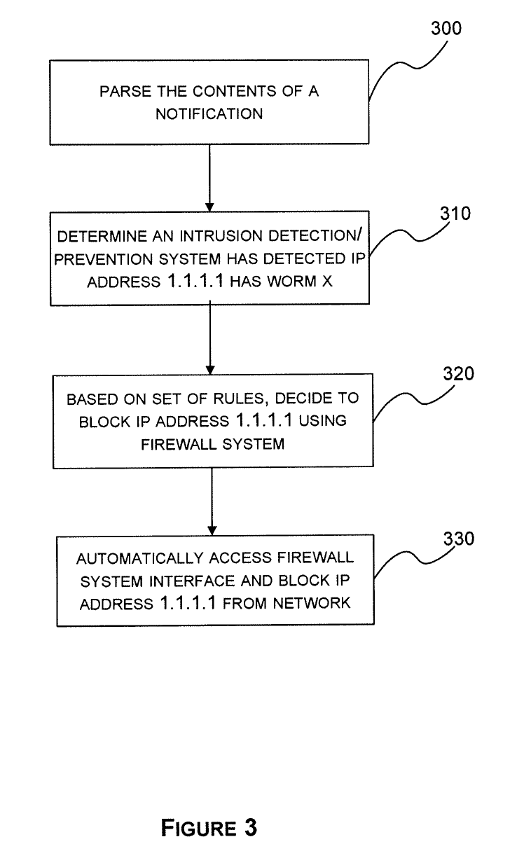

FIG. 3 illustrates routines and actions performed by exemplary components of an integration device. The exemplary routines can be stored as a process accessible by rules engine 140, action engine 145, or other components of integration device 100, and may use rules repository 125. Depending on the embodiment, some of the blocks described below can be removed, others may be added, and the sequence of the blocks may be different.

Beginning in block 300, the contents of a notification may be parsed. The notification may include any information collected from security devices 170A-N or security information management system 155. In an embodiment, the notification may include information related to security events, incidents, transactions, attacks, etc., originating at a security device.

Moving to block 310, after parsing the contents of the notification, it may be determined that an intrusion detection or prevention system has detected a computing device being monitored may have a vulnerability. For example, in the illustrated embodiment, the computing device associated with an internet protocol address (e.g., 1.1.1.1) has a worm (e.g., worm X). The contents of the notification may identify this vulnerability directly, or integration device 100 may make this determination by analyzing the contents (e.g., event logs) of the notification from the monitored computing device and correlate the contents with a database of worms, for example.

Continuing to block 320, it may be determined that the internet protocol address (e.g., 1.1.1.1) should be blocked using a firewall system. For example, the rules engine 140 may compare the contents of the notification against a rules repository 125. The rules repository 125 may include a rule that specifies a condition, such as worm X is detected by an intrusion detection or prevention system on a monitored computing device. The rule may further specify an action to take when the condition is met, such as use the firewall system to block the internet protocol address (e.g., 1.1.1.1) of the monitored computing device. Of note, other actions may be taken on different security devices using the same rule or different rules.

Moving to block 330, the firewall system interface may be accessed automatically and the internet protocol address (e.g., 1.1.1.1) may be blocked from joining the monitored network. For example, action engine 145 may send commands over a connection to firewall system in any language understood by the firewall system interface. In an embodiment, the firewall system interface may be configured to receive internet protocol addresses to block through secure shell, secure socket layer, HTTP or other protocols and languages.

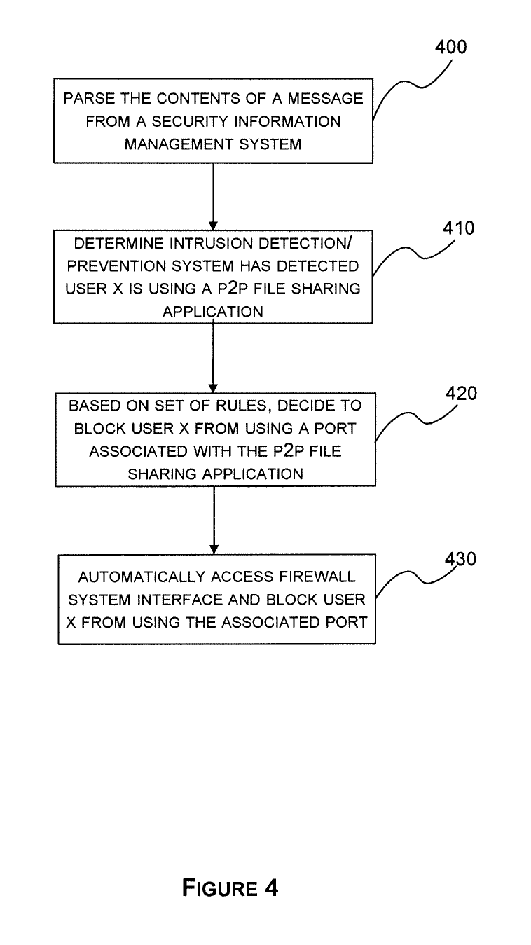

FIG. 4 illustrates routines and actions performed by exemplary components of an integration device. The exemplary routines can be stored as a process accessible by rules engine 140, action engine 145, or other components of integration device 100, and may use rules repository 125. Depending on the embodiment, the method of FIG. 4 can include fewer or additional blocks, and blocks can be performed in an order that may be different than illustrated.

Beginning in block 400, the contents of a message may be received and parsed. An integration device 100 may receive the message from a security information management system 155, or alternatively, from security devices 170A-N. The messages can be parsed by rules engine 140 and compared against a set of rules which can specify actions to take when a condition may be met, such as rules repository 125.

At block 410, the contents of the message have been parsed, and it may be determined that an intrusion detection or prevention system has detected a user (e.g., user X) is a using a peer-to-peer file sharing application, for example. This information can be extracted from the contents directly or by performing an analysis by correlating the contents (e.g., network usage data) with a database of applications which may be capable of identifying application types based on network usage data. In some embodiments, integration device 100 may perform this analysis when the message is received directly from security devices 170A-N.

Moving to block 420, based on a set of rules, it may be decided to block the user (e.g., user X) from using a port associated with the peer-to-peer file sharing application. Rules engine 140 may query rules repository 125 that includes a set of one or more rules. The rules may include conditions, that when satisfied, indicate actions to take on security devices which may be different than a security device in which the underlying contents of the message originated or relate to. In the illustrated embodiments, a condition is satisfied that an intrusion detection or prevention system has detected a user is using a peer-to-peer file sharing application. Because the condition is satisfied, an action may be selected that blocks the user (e.g., user X) from using a port associated with the file sharing application. Of note, other actions to take on different security devices may be selected when a condition is satisfied, such as using a network access control system to ban the user from the monitored computer network.

Continuing to block 430, a firewall system may be automatically accessed and the user (e.g., user X) may be blocked from using the port associated with the file sharing application. In some embodiments, an interface, such as a firewall system interface, may be used by action engine 145 to send communications to take actions on the firewall system. In the illustrated embodiment, commands may be sent that include the identity of the user (e.g., internet protocol address or user name) and the associated port of the file sharing application to limit the user's access. Advantageously, information from a security device to which the message contents relate can thus be used to determine actions to take at different security devices in order to improve security of the monitored network.

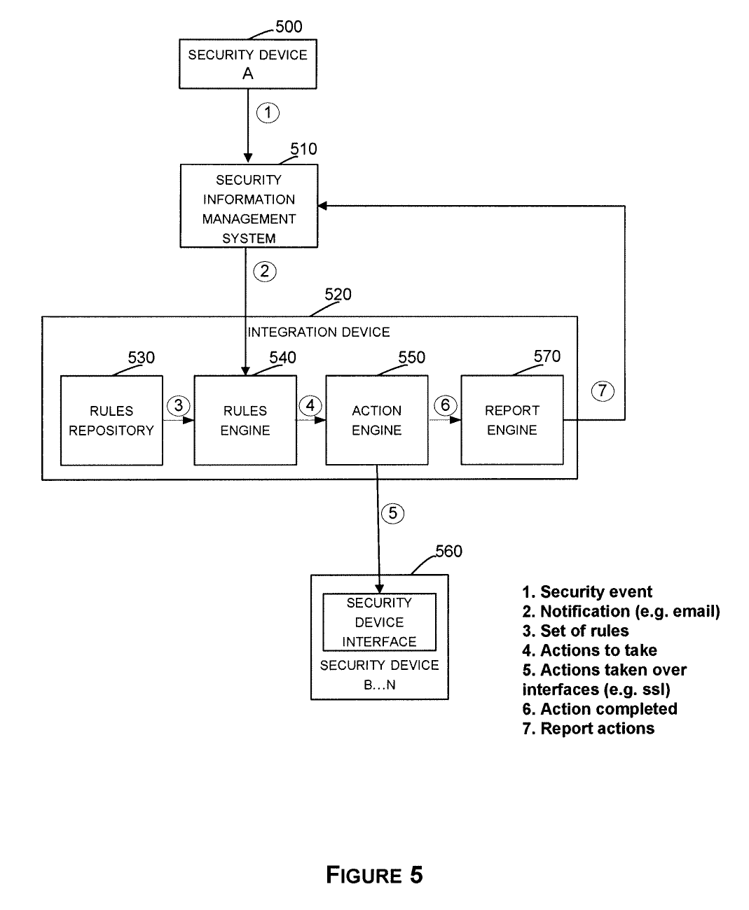

FIG. 5 illustrates a flow diagram of security management performed by exemplary components of the systems of FIGS. 1A-C. In some embodiments, the illustrated routines can be performed by integration device 100, security information management system 155, security devices 170A-N, and various components of these devices. Depending on the embodiment, the method of FIG. 5 can include fewer or additional blocks, and blocks can be performed in an order which may be different than illustrated.

Beginning in block 500, security device 170A may send information to security information management system 155. The information can be sent using a variety of applications or protocols, such as syslog, secure syslog, electronic mail messages, alerts, alarms, etc. The information can relate to events, incidents, activities, attacks, etc. that may occur on the monitored network or computing devices. In addition, the information sent may include application logs, event logs, network packets, network usage data, electronic mail messages, etc. that can be generated at security device 170A or by computing devices and applications on a monitored computer network. Still further, the information sent may be related to software and hardware configurations of computing devices and network devices being monitored (e.g., types of operating systems, services offered, etc.), transaction data related to data flowing through the monitored computer network or computing devices, blacklisted or greylisted databases, etc.

Moving to block 510, security information management system 155 may receive the information from security device 170A and send a notification with information to integration device 100 using notification application 160. Notification application 160 may be configured to send the notification as a message, alarm, alert, etc. Notification application 160 may send the information over network 180 to integration device 100 using any format or protocol, for example: electronic mail, simple network management protocol (SNMP), extensible markup language (XML), hypertext transport protocol (HTTP), secure socket layer (SSL), syslog server, secure syslog, remote copy (rcp), secure copy (scp), file transfer protocol (ftp), secure file transfer protocol (sftp), etc.

Moving to block 520, the notification is received by integration device 100 over network 180, for example. Integration device 100 may be capable of sharing security information among the plurality of security devices 170A-N and taking actions on the security devices 170A-N. Continuing to block 530, rules repository 125 can provide a set of rules having a condition and action to take when the condition may be met to rules engine 140. At block 540, rules engine 140 queries the rules repository 125 for the set of rules and compares the contents of the notification to the rules. In an embodiment, when a rule condition may be matched, rules engine 140 selects actions to take at security devices 170B-N based on the matched rule.

At block 550, action engine 145 establishes a connection with security devices 170B-N and takes the actions. At block 560, the actions can be performed on security devices 170B-N using respective security device interfaces 175B-N to issue commands. For example, action engine 145 may send commands using HTTP post or shell scripts, using secure socket layer or a secure shell connection, respectively. Moving to block 570, report engine 150 reports the actions taken to the security information management system 155 or security devices 170A-N. This may allow additional actions to be taken, based on actions that have occurred and allow the security system to be driven by feedback.

It will be apparent to those skilled in the art that various modifications and variations can be made in the present disclosure without departing from the spirit or scope of the disclosure. Thus, it is intended that the present disclosure cover any modifications and variations within the scope of the appended claims and their equivalents.

What is claimed is:

1. An integration device for exchanging information related to security among different security devices, the device comprising:
a network interface configured to receive a notification of a security event at a first security device;
a computer memory configured to store a set of rules; and
a processor configured to compare the contents of the notification against the set of rules, select actions to take based on the set of rules at one or more other security devices, establish a connection to the one or more other security devices using the network interface, and take the actions over the connection.

2. The integration device of claim 1, wherein the other security devices comprise at least one security device of a different platform than the first security device.

3. The integration device of claim 1, wherein the other security devices comprise at least one security device which is not interoperable with the first security device.

4. The integration device of claim 1, wherein the processor is configured to take the actions by sending commands understood by the one or more other security devices over the connection.

5. The integration device of claim 1, wherein the processor is configured to take the actions using an application programming interface provided by the one or more other security devices.

6. The integration device of claim 1, wherein the processor is operable to configure the set of rules using best practices selected by an administrator.

7. The integration device of claim 1, wherein the network interface is configured to receive a set of security policies from a security information management system.

8. The integration device of claim 7, where in the processor is operable to configure the set of rules using the received set of security policies.

9. The integration device of claim 1, wherein the notification comprises an electronic mail message.

10. A computer-implemented method of sharing security information among security systems, the method comprising:
receiving a message from a security information management system related to a security event at a first security system;
parsing contents of the message; and
automatically taking an action on a second security system based on the contents of the message;

11. The method of claim 10, further comprising reporting the actions taken at the second security system to the security information management system.

12. The method of claim 10, wherein the taking the action comprises establishing a connection to the second security system over a network and issuing commands over the connection.

13. The method of claim 12, wherein the commands are in a language understood by second security system.

14. The method of claim 12, wherein the connection comprises a secure socket layer connection.

15. The method of claim 12, wherein the connection comprises a secure shell connection.

16. The method of claim 12, wherein the commands are written for a command line interpreter of the second security system.

17. A computer readable medium having stored thereon computer executable components, the medium comprising:
a rules engine that receives a notification including information related to a security event at a security device, matches the security event against one or more rules, and identifies actions to take at one or more different security devices when the security event matches the one or more rules; and
an action engine that takes the actions on the one or more different security devices.

18. The computer readable medium of claim 17, wherein the action engine takes the actions by setting up a connection with each of the different security devices and issues commands over the connection using an interface understood by each different security device.

19. The computer readable medium of claim 17, wherein the rules engine sends contents of the notification to an electronic mail server for delivery to a recipient when the one or more rules are not matched.

20. The computer readable medium of claim 17, wherein the one or more different security devices comprise a network access control system.

21. The computer readable medium of claim 17, wherein the one or more different security devices comprise a host intrusion prevention system.

22. The computer readable medium of claim 17, wherein the one or more different security devices comprise an intrusion detection system.

23. The computer readable medium of claim 17, wherein the one or more different security devices comprise a firewall system.
